(19) United States
(12) Patent Application Publication
(10) Pub. No.: US 2011/0044483 A1
(43) Pub. Date: Feb. 24, 2011

(54) METHOD AND APPARATUS FOR SPECIALIZED GESTURE SENSING FOR FITTING HEARING AIDS

(75) Inventor: Dan Edgar, Lakeville, MN (US)

Correspondence Address: SCHWEGMAN, LUNDBERG & WOESSNER, P.A., P.O. BOX 2938, MINNEAPOLIS, MN, 55402, US

(73) Assignee: Starkey Laboratories, Inc., Eden Prairie (US)

(21) Appl. No.: 12/543,174

(22) Filed: Aug. 18, 2009

(51) Int. Cl. H04R 25/00

(52) U.S. Cl. 381/314

(57) ABSTRACT

The present subject matter relates generally to method and apparatus for sensing gestures for fitting hearing aids.

### FIELD OF THE INVENTION

The present subject matter relates generally to fitting hearing aids, and in particular to method and apparatus for specialized gesture sensing for fitting hearing aids.

### BACKGROUND

Wearers of hearing aids undergo a process called “fitting” to adjust the hearing aid to their particular hearing and use. In such fitting sessions the wearer may select one setting over another, much like selecting one setting over another in an eye test. Other types of selections include changes in level, which can be a preferred level. A hearing aid fitting system is currently controlled via standard mouse and keyboard input. These input devices center around an audiologist or dispenser having access to a mouse and keyboard while tending to a patient. The standard keyboard and mouse input devices can interfere or preclude patient participation in the fitting process. Furthermore, these sessions require user input, which can be tedious and repetitious. Thus, there is a need in the art for improved communications from wearer to audiologist for performing fitting.

### SUMMARY

Disclosed herein, among other things, are methods and apparatus for method and apparatus for specialized gesture sensing for fitting hearing aids. These novel input devices aid in a fitting, simplify the fitting process, remove the restriction of mouse and keyboard, and allow patient participation in the fitting process.

This Summary is an overview of some of the teachings of the present application and not intended to be an exclusive or exhaustive treatment of the present subject matter. Further details about the present subject matter are found in the detailed description and appended claims. The scope of the present invention is defined by the appended claims and their legal equivalents.

### BRIEF DESCRIPTION OF THE DRAWINGS

FIG. 1 shows a fitting system with gesture sensing according to various embodiments of the present subject matter.

### DETAILED DESCRIPTION

The following detailed description of the present subject matter refers to subject matter in the accompanying drawings which show, by way of illustration, specific aspects and embodiments in which the present subject matter may be practiced. These embodiments are described in sufficient detail to enable those skilled in the art to practice the present subject matter. References to “an”, “one”, or “various” embodiments in this disclosure are not necessarily to the same embodiment, and such references contemplate more than one embodiment. The following detailed description is demonstrative and not to be taken in a limiting sense. The scope of the present subject matter is defined by the appended claims, along with the full scope of legal equivalents to which such claims are entitled.

The present subject matter of the invention relates generally to method and apparatus for specialized gesture sensing for fitting hearing aids. A hearing aid fitting system is currently controlled via standard mouse and keyboard input. These input devices center around an audiologist or dispenser having access to a mouse and keyboard while tending to a patient. The standard keyboard and mouse input devices can interfere or preclude patient participation in the fitting process.

The present subject matter relies on the use of novel fitting system input devices to act on gestures that an audiologist or patient can make to augment the fitting process. These novel input devices aid in a fitting, simplify the fitting process, remove the restriction of mouse and keyboard, and allow patient participation in the fitting process. Examples of these devices include, but are not limited to: a wireless remote control, such as a Wii Remote Control, a wireless gyroscopic mouse, and head or camera mice. Other such devices and interfaces may be used without departing from the scope of the present subject matter.

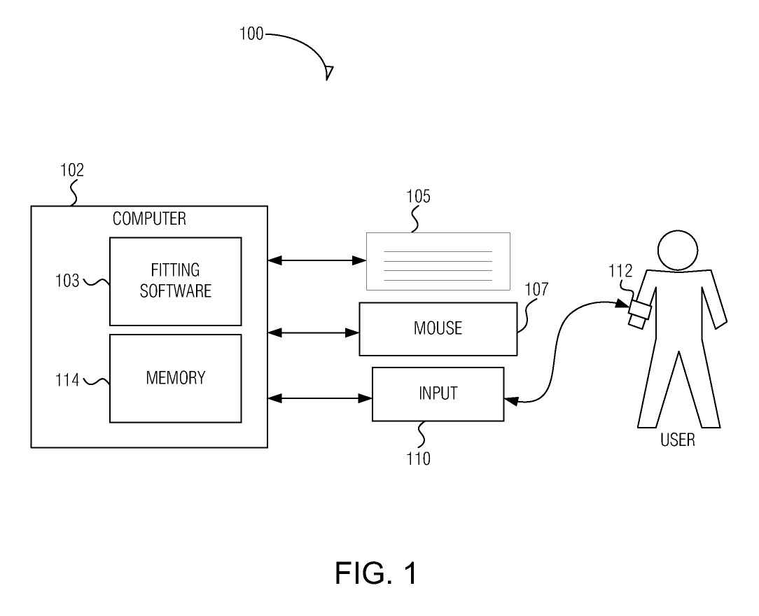

FIG. 1 shows a fitting system with gesture sensing according to various embodiments of the present subject matter. Computer 102 is adapted to execute fitting software 103 that takes traditional inputs from devices such as keyboard 105 and mouse 107 for fitting one or more hearing aids 120. The system 100 is also adapted to sense gestures using input 110 that is connected to the computer 102. In various embodiments, the user may make gestures with or without another unit to track their gestures. For example, if input 110 is a camera or other type of motion detector, the user may make gestures that are sensed by just the motion. In various embodiments, the user is wearing a device to assist in the motion detection, such as a wireless unit or reflector or other such device 112. It is understood that the user may be the wearer of one or more hearing aids or can be a clinician, audiologist or other attendant assisting with the use of the fitting system 100. The system 100 includes memory 114 which relates a plurality of gestures with a plurality of operations for the fitting system. It is understood that the configuration shown in FIG. 1 is demonstrative and is not intended in an exhaustive or exclusive sense. Other configurations may exist without departing from the scope of the present subject matter. For example, it is possible that the memory 114 may be encoded in firmware, software, or combinations thereof. It is possible that the system may omit a mouse or a keyboard or may include additional input/output devices without departing from the scope of the present subject matter. Other variations are possible without departing from the present subject matter.

The input device facilitates a series of physical movements and gestures that an audiologist or patient can make to assist in a fitting. In various embodiments, the gestures are unique to hearing aid fitting. Such gestures are detected and outcomes in the fitting software are realized depending on the particular gesture used.

In various embodiments, gestures for fitting the hearing aid are augmented with video and audio feedback. In various embodiments, the specific gestures are intuitive extensions of typical responses by individuals. One example is a head gesture up and down for “yes” and side to side for “no.” Other gestures for example, include quick upward head movements or “thumbs up” movements for “more.” A “thumbs down” gesture can be used for less. And an OK sign (thumb to finger in a circle) can be used for a setting that is good for the user.

There are a myriad of input devices that can track gestures. These input devices have software and hardware linkages with computers. The fitting software can perform many functions when the gesture triggers. This process has the possibility to eliminate or reduce mouse tracking/seek. It can also avoid non-intuitive keyboard key shortcuts which may not be known to some persons. It can alleviate the need for “expert” learning of a system. It can also limit the amount of icon/graphic use, because gestures can perform major functions of the software.

The use of gestures can also immerse a patient in their own hearing aid fitting. A patient can be exposed to a simulated media environment (i.e. 5.1 Surround Sound), and through the logging of gestures during the simulation the hearing aid can be adjusted according to patient specifications driven from the gestures.

In various embodiments, gestures are logged and recorded for playback at a later time, either via video or just the gesture stream.

In various embodiments, specialized input devices are created depending on the outcome of user studies. For example, a color (i.e. Red/Green) may be substituted indicators of bad and good. An input device that indicates bad/good in the most intuitive manner will aid in this effort. Examples of use of color on an input device include the TiVo Remote (Green Thumb Up=Good, Red Thumb Down=Bad). In the case of the TiVo remote the use of many cues is a reinforcement for the operation at hand. The present subject matter applies such cues toward a medical/diagnostic purpose.

Another approach is the use of a “dial meters” where a low extreme of the dial is “disagree” and a high extreme of the dial is “agree.”

The following sample gestures are useful for input devices that are held and motion sensing (such as with an accelerometer, as in the case of a Nintendo Wii Remote). It is understood that these gestures are provided to demonstrate the invention and are not intended in an exhaustive or exclusive sense:

Gestures to indicate which ear has a problem: an example is to hold the input device in the hand that corresponds to the ear side.

Gestures for Best Fit: an example gesture is a double shake to automatically Best Fit the hearing aid. Another example is to press and hold a button.

Gestures for Environment Change: one example is a twirl of an input device in a circle. Such embodiments may cycle the current memory environment to the next environment.

Gestures for Louder/Softer and different extremes of Louder/Softer: one example is to hold the input device and tilt the device up or down. Holding down a button on the input device would allow for fine tuning of the louder/softer response.

Gesture to cycle to next/previous adjustment: one example is to tilt the device side to side with a slight acceleration. Right to go to next adjustment, left to go to previous adjustment.

Gestures to start playing certain kinds of media files: one example is to point and click on hotspot on screen. Or press a button and shake to get the next media file to play.

Gestures for “Start Over”: one example is to “scribble” the device in the air rapidly.

Gestures for “Undo last change”: some examples are to double shake with a left twist to Undo and to double shake with a right twist to Redo.

Many other gestures can be derived for what kind of specific adjustment to make. For example, adjustments in band, indicator tone, for signaling when everything is O.K., for signaling when something is not right, for starting a session, for signaling when a session is complete, to start a new process, or for other specialized functions.

One way to terminate a session is to set down the input device, or simply have the input device go out of range of the computer.

Various programming options exist for gaming controls that can be adapted for use with hearing aid fitting. For example, there is a free framework known as GlovePIE that can map the Nintendo Wii controller to standard Windows events. There are also direct drivers that relay the values from the Nintendo Wii remote which allow a software developer to detect gestures and give meaning to those gestures via feedback within software applications. Other programming environments exist and are being developed which can be used with the present subject matter.

The present subject matter is demonstrated in the fitting of hearing aids, including but not limited to, behind-the-ear (BTE), in-the-ear (ITE), in-the-canal (ITC), or completely-in-the-canal (CIC) type hearing aids. It is understood that behind-the-ear type hearing aids may include devices that reside substantially behind the ear or over the ear. Such devices may include hearing aids with receivers associated with the electronics portion of the behind-the-ear device, or hearing aids of the type having receivers in the ear canal of the user. The present subject matter can also be used in hearing assistance devices generally, such as cochlear implant type hearing devices. It is understood that other hearing assistance devices not expressly stated herein may be used in conjunction with the present subject matter.

This application is intended to cover adaptations or variations of the present subject matter. It is to be understood that the above description is intended to be illustrative, and not restrictive. The scope of the present subject matter should be determined with reference to the appended claims, along with the full scope of legal equivalents to which such claims are entitled.

What is claimed is:

1. A method for fitting a hearing aid worn by a wearer with a fitting system, comprising:
programming an interface to the fitting system adapted to input a plurality of gestures by a user of the system during a fitting session and adapted to convert each of the gestures into information useable by the fitting system for the fitting session.

2. The method of claim 1, wherein the information includes instructions for operating the fitting system based on the gestures.

3. The method of claim 1, wherein the information includes settings for the fitting system based on the gestures.

4. The method of claim 1, wherein the information includes settings for the hearing aid based on the gestures.

5. The method of claim 1, further comprising logging the gestures during the fitting session.

6. The method of claim 1, wherein the information indicates starting a fitting session.

7. The method of claim 1, wherein the information includes an indicated ear.

8. The method of claim 1, wherein the information indicates an environment change.

9. The method of claim 8, further comprising cycling a current memory environment to another environment.

10. The method of claim 1, wherein the information indicates a louder or softer volume setting.

11. The method of claim 1, wherein the information indicates playing certain media files.

12. The method of claim 1, wherein the information indicates to start the fitting session over.

13. The method of claim 1, wherein the information indicates that the fitting system should undo its last sensed change.

14. The method of claim 1, further comprising terminating the fitting session based on the information.

15. A system for sensing a plurality of gestured inputs to a fitting system for fitting a hearing aid, the fitting system executing on a computer, the system comprising:
an input device for sensing the plurality of gestured inputs made remotely from the computer to communicate with the fitting system; and
computer readable information stored in memory to associate each of the plurality of gestures with an operation used in fitting the hearing aid,
wherein the computer readable information is accessible by the computer to convert each of the plurality of gestures into an appropriate instruction to operate the fitting system based on each of the plurality of gestures.

16. The system of claim 15, wherein the input device is a camera in communications with the computer.

17. The system of claim 15, wherein the input device is a wireless remote control adapted for handheld use and a sensor element in communications with the computer.

18. The system of claim 15, wherein the input device is a head mounted mouse.

19. The system of claim 15, wherein the input device is a wireless gyroscopic mouse.

20. The system of claim 15, wherein the input device is a camera mouse.
